(19) United States
(12) Patent Application Publication
(10) Pub. No.: US 2017/0242961 A1
(43) Pub. Date: Aug. 24, 2017

(54) SYSTEMS AND METHODS FOR PERSONAL OMIC TRANSACTIONS

(71) Applicant: Indiscine, LLC, Wilmington, DE (US)

(72) Inventors: Sachet Ashok Shukla, Newton, MA (US); Madhukar Anand, Fremont, CA (US); Jahnavi Chandra Prasad, Wilmington, DE (US)

(21) Appl. No.: 15/113,600

(22) PCT Filed: Jan. 23, 2015
(86) PCT No.: PCT/US15/12679

§ 371 Date: Jul. 22, 2016

Related U.S. Application Data
(60) Provisional application No. 61/931,259, filed on Jan. 24, 2014.
(60) Provisional application No. 62/004,214, filed on May 29, 2014.

(51) Int. Cl. G06F 19/28; G06F 21/53; H04L 9/08; G06F 21/60; H04L 29/06; G06F 21/45; G06F 19/00; G06F 21/62

(52) U.S. Cl. CPC G06F 19/28; G06F 19/366; G06F 21/53; G06F 21/6245; G06F 21/602; H04L 63/0281; H04L 63/0272; H04L 63/0428; G06F 21/45; H04L 9/0819

(57) ABSTRACT

Systems and methods for conducting secure, privacy-preserving, verifiable omic transactions are provided. An omic service may authenticate one or more individual users and store each users omic information as encrypted data, without storing decryption keys, and also ensure fidelity and correct correspondence of each user's data with the user. A dedicated private virtual appliance can be instantiated to obtain encrypted omic data, query each user for decryption keys, decrypt the user omic data, perform an omic calculation, report results and terminate itself, thereby erasing all copies of decrypted user omic data. Alternatively, the appliance can operate with user-managed genome storage. A genome-on-a-stick construct facilitates end user interaction with such omic service providers.

### TECHNICAL FIELD

The disclosure relates in general to biological profiling, and in particular to systems, and methods for privacy-preserving transactions involving omic information.

### BACKGROUND

Multivariate profiling on an individual's biological makeup for medical, prognostic and personal use is becoming commonplace. Genetic sequencing and profiling technology has advanced rapidly in recent years. The cost of genome sequencing is plummeting, while the availability of genomic sequencing technology is becoming more prevalent around the world. Simultaneously, we are rapidly improving our ability to draw meaningful personal health information from genomic data. We are quickly moving towards an environment in which individuals will be able to affordably have their whole genome sequenced and utilized regularly for personalized health insight and medical treatment.

Given the availability of omic data and the ability to draw valuable insight from it, multiple types of computations may be of interest to various consumers and service providers. Some examples using one person's genome include identification of health risks, abilities, and nutritional needs. Other insights can be drawn from analysis of genomic information for multiple individuals, such as determinations of relatedness, or genomic compatibility in terms of health of potential offspring. The ability to draw such insights from genomic data may give rise to an opportunity for the rapid proliferation of omic transactions involving one or multiple participating entities in a wide variety of scenarios.

However, personal genome sequencing and analysis gives rise to significant challenges relating to privacy, information security and information authenticity. Genetic sequence data can reveal highly sensitive information about an individual, including the presence or propensity to develop genetic diseases and conditions, and even behavioral predispositions. Malicious use of genetic data could lead to privacy violation, genetic discrimination, and other harmful consequences. Individuals may desire to maintain some or all of their genetic information private from other people against whom they would like to test for potential compatibility, as well as from doctors and service providers who may require access to only a limited portion of genetic information, for limited purposes. Accordingly, to unlock the full potential benefits of genetic sequencing and analysis, it may be important to provide mechanisms for preserving the privacy of genomic sequence data during the course of an omic transaction.

One particularly valuable use of genomic computation is for evaluating the compatibility of individuals for purposes of having children, and specifically for identifying potential risks of genetic disease or other attributes in the potential offspring. Individuals being tested for compatibility may desire to learn specific information regarding their potential offspring, but each party may wish to avoid or minimize any potential disclosure of their own genetic information. Solutions to this issue have been proposed. One approach is for individuals to each provide their genomic data to a trusted third party for analysis, with the primary parties receiving only the results of the testing. However, in such a scenario, a participant's genomic privacy could be readily violated as a result of malicious action on or by the third party testing facility, such as a hacking attack, employee misconduct or organizational misuse. With such testing facilities acting as centralized repositories for highly sensitive genetic information, they may be particularly likely to be targeted for attack.

Another approach to preserve privacy in genomic transactions is to utilize combinations of data encryption and computational techniques in order to enable calculations on genomic data, without revealing the entirety of that genomic data to any one party. Such techniques are described in, e.g., PCT Patent Publication Nos. WO 2014/040964 A1, WO 2013/067542 A1 and WO 2008/135951 A1. One such technique that has been considered for application to genomic data is Secure Multiparty Computation (hereinafter, “SMC”). SMC techniques, such as Yao's Garbled Circuits technique, enable two parties to jointly compute a function while keeping their inputs private. SMC has been proposed for use to enable two individuals to test their genetic compatibility without disclosing their gene sequence data to one another.

Another approach to computational privacy is homomorphic encryption. In theory, homomorphic encryption techniques enable the performance of computations on encrypted data, without decrypting the data, thereby yielding a computationally sound result of a calculation without disclosing the input data.

While computational privacy techniques such as SMC and homomorphic encryption may protect against malicious breach of genetic privacy, they are also highly computationally intensive. For certain applications, they may require a burdensome or even impractical amount of time or computational resources.

Existing SMC and homomorphic encryption approaches may not address other characteristics that may be desirable in a platform for genomic computation. For example, in a computation platform testing for genetic compatibility between potential mates, it may be important to provide for verification of data integrity to ensure that each party's genomic data has not been intentionally altered or unintentionally corrupted. Users or operators of such a platform may also desire to provide for data authentication, to verify that provided genomic data actually belongs to the intended individual. The success and desirability of certain genomic computation platforms may also require a convenient mechanism by which users can securely interact with the platform. Some of these and other factors may be addressed by certain of the embodiments described hereinbelow.

### SUMMARY

The present disclosure describes systems and methods for privacy-preserving computation on genomic information. The system can be implemented within various networked computing environments, involving various combinations of one or more users and, in some embodiments, an omic service provider.

In accordance with one embodiment, an omic transaction service is provided, which is hosted on one or more servers communicating with one or more users via a digital communications network to execute an omic transaction. The servers typically have one or more processors and memory storing instructions which, when executed by the processors, cause the servers to perform various methods.

In accordance with one exemplary method, a virtual appliance is instantiated for purposes of an omic transaction. The virtual appliance can be instantiated on demand, or pre-generated and maintained in standby until assignment to a particular omic transaction. Once assigned, the virtual appliance receives one or more sets of encrypted omic data, each set of encrypted omic data being associated with one of the users. The encrypted data can be transferred to the virtual appliance directly from user electronic devices, from user-managed networked data storage repositories, or from omic service provider-managed cloud storage resources. In some embodiments, an omic service provider manages data and software necessary to perform an omic transaction within a private cloud storage resource, and that data and software for the omic transaction is included with the virtual appliance at the time it is launched.

In other embodiments, the omic service provider may act as a trusted platform, facilitating secure interaction between individuals and a variety of third party providers of omic computation, processing and/or storage services. In such embodiments, some or all of the data and software required to perform an omic computation may be available within an external third party cloud or computing resource. The omic service provider-instantiated virtual appliance may then perform a variety of roles, including, without limitation: directly contacting the third party cloud or vendor; implementing a privacy-preserving computation protocol, such as Garbled Circuits or homomorphic encryption, to jointly perform the omic transaction with the third party; securely receiving third party data and/or algorithms for transitory use within the virtual appliance; providing genomic data anonymously to the third party for processing, with the returned result re-associated with the individuals for whom omic information was provided by the virtual appliance; or interacting through a secure connection directly with a virtual appliance launched by the third party to perform the computation.

The virtual appliance also receives a decryption key for each set of encrypted omic data. The virtual appliance applies the decryption keys to the sets of encrypted omic data to generate decrypted omic data. The virtual appliance then performs an omic transaction, which includes calculations performed using the decrypted omic data, to generate a transaction result. The transaction result is transmitted to one or more of the users, and the virtual appliance is terminated, preferably eliminating any remaining copies of the decrypted omic data within computing resources managed by the omic service provider.

In accordance with another embodiment, systems and methods are provided for authenticating omic transactions using a secure digest of omic data. The secure digests are generated by applying predetermined one-way functions, such as hash calculations, to sets of omic data. Verified secure digests are preferably generated prior to an omic transaction, by applying the predetermined one-way function to pre-authenticated omic data. At the time of a transaction, a current secure digest can be generated by applying the predetermined one-way function to the omic data received for use in the transaction. The transaction can be determined to have failed authentication if the current secure digest is inconsistent with the verified secure digest. In some embodiments, storage of verified secure digests can be implemented using a persistent storage server, while each omic transaction is performed by a transitory virtual appliance.

In accordance with another embodiment, an end-user controlled electronic system is provided for facilitating omic transactions. The system can preferably be implemented partially or fully within a portable electronic device. The system includes an omic data storage repository containing an encrypted set of omic data comprising multivariate biological data regarding an individual and metadata associated therewith. The omic data storage repository can be implemented locally within the system, such as via nonvolatile digital memory, or remotely within a networked data storage system. A microprocessor is in operable communication with the omic data storage repository. A communications network interface enables data communications between the microprocessor and third party electronic systems. The microprocessor is operable to decrypt the omic data, and calculate a secure digest by applying a predetermined one-way function to the decrypted omic data. The microprocessor is further operable to transmit the encrypted omic data and the secure digest to a third party electronic system. Subsequently, the microprocessor is further operable to engage in an omic transaction with the third party electronic system. In one such embodiment, the omic transaction may involve authenticating with the third party system, transferring a decryption key to the third party system operable to decrypt the omic data, and receiving a result of the omic transaction from the third party system. Preferably, at least the portion of the third party system responsible for processing the decrypted omic data is implemented by a transitory virtual appliance that is terminated following completion of the omic transaction.

Various other objects, features, aspects, and advantages of the present invention and embodiments will become more apparent from the following detailed description of preferred embodiments, along with the accompanying drawings in which like numerals represent like components.

### BRIEF DESCRIPTION OF THE DRAWINGS

FIG. 1 is a schematic block diagram of a computing environment for omic transactions.

FIG. 2 is a process diagram for performing a one party genomic computation with a private virtual appliance and cloud-based genome storage.

FIG. 3 is a process diagram for performing a multi-party genomic computation with a private virtual appliance and cloud-based genome storage.

FIG. 4 is a schematic block diagram of a system for generating an omic information secure digest.

FIG. 5 is a process diagram for performing a one party omic computation using a private virtual appliance with user-end genome storage.

FIG. 6 is a process diagram for performing a multi-party omic computation using a private virtual appliance with user-end genome storage.

FIG. 7 is a schematic block diagram of a genome-on-a-stick to facilitate personal omic transactions.

FIG. 8 is a schematic block diagram of a computing environment for omic transactions using homomorphic encryption techniques.

FIG. 9 is a process diagram for performing a one party omic computation with verification and authentication using homomorphic encryption techniques.

FIG. 10 is a process diagram for performing a multi-party omic computation with verification and authentication using homomorphic encryption techniques.

FIG. 11 is a process diagram for performing a multi-party omic computation using homomorphic encryption and split encryption keys.

FIG. 12A is a schematic block diagram of an environment for performing a peer-to-peer omic transaction.

FIG. 12B is a process diagram for performing a peer-to-peer omic transaction using homomorphic encryption.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Embodiments of the systems and methods described herein facilitate omic transactions. Some embodiments may also potentially overcome limitations of existing systems that are believed to limit their widespread adoption and realization of the full benefits of omic analysis. For example, some embodiments may provide beneficial combinations of privacy, security, data authentication, data quality, ease of use and computational efficiency.

Privacy:

Privacy may be important to the extent people want to explore the various interpretations of their personal omic data (e.g., to determine ancestry or medical vulnerabilities) without revealing either their personal identity or the information gleaned from their genome to other parties. People may also wish to engage in omic transactions involving other people (e.g. to determine relatedness, genetic compatibility in terms of predicted health of potential progeny, or compatibility assessments for transplantation of organs or tissues) but do so in a manner that does not reveal their data to the other individual or to any third party that might be providing the service.

Security:

Data security should preferably be guaranteed during all applications and services involving omic data (sometimes referred to herein as ‘omic transactions’). Also once a person's genome or other omic data has been profiled, it may preferably be stored securely so that unauthorized parties do not get access to it or glean profitable information from it.

Data Authenticity:

Establishing data authenticity may be important to safeguard transactions involving personal omic data against masquerading and manipulation attacks. In multiparty omic transactions involving trust there should be protection against data tampering by any party.

Data Quality:

Omic data may be of varying qualities, formats and types depending on the source, profiling technology used, software used for analysis and other aspects. In omic transactions, it may be useful to have a mechanism that would help participating entities to judge the fidelity or believability of the other party's omic data. This can be enabled by including provenance information for data used in omic transactions.

Ease of Use:

With a number of available service providers, applications, and omic data storage options, end-consumers may want the freedom to, (a) choose the method of secure storage of the personal genomic data, (b) easily and securely retrieve the data from the storage device, and (c) use their favorite application to process the genomic data. Additionally they will want the process to be simple. The underlying omic data storage and processing technology will, therefore, preferably enable this ‘plug and play’ simplicity, freedom and ease of use for genomic data processing.

Computational Efficiency:

Certain omic datasets may be massive in size, and some types of operations may require significant computational resources. Therefore, it may be important in some use cases to implement systems that are computationally efficient in order to deliver timely and cost-effective results.

Described herein are, amongst other things, embodiments of systems and methods for addressing some or all of the above challenges. Techniques that may be applied alone or in combination include (i) cloud-based private virtual appliance with omic service provider-managed genome storage, (ii) cloud-based private virtual appliance with user-managed genome storage, (iii) systems utilizing homomorphic encryption, and (iv) a “genome-on-a-stick” paradigm potentially facilitating ease-of-use in such systems for conducting omic transactions.

To facilitate this disclosure, the terms omic, genomic and genome may be used interchangeably to refer to any combination of genomic, epigenetic, transcriptomic, metabolomics, proteomic, metagenomic, viromic or other such multivariate biological data. The term omic service provider will refer to an entity offering omic computation and/or storage services. The term “trusted cloud server” refers to a server on a cloud computing platform used by the omic service provider for omic data manipulation and storage. Such a cloud computing platform may be a public cloud platform (such as, e.g., Amazon AWS, Microsoft Azure or Google Compute Engine), a private cloud computing platform, or a hybrid public/private cloud computing platform.

The systems and methods described herein are explained in the context of one of several types of omic transactions. One such transaction type is genomic annotation, a one-party genomic computation problem statement. For example, genomic annotation may involve a person whose genome has been sequenced who wishes to know the latest interpretation, assessment of health risks, and ancestry-related information. Oftentimes such a person would prefer to gain this insight without compromising his or her privacy. Another transaction type is a multi-party genomic computation, such as genomic compatibility and relatedness computations. For example, a man and woman may be interested in exploring their mutual genomic compatibility in the context of having healthy children in the future. Each of them have their own genomic data available to them, which they are considering submitting to an omic service provider for analysis, and they may prefer to accomplish this estimation of their compatibility in a manner that is completely private with respect to the third party service provider as well as each other. Another type of multi-party omic transaction involves assessing the compatibility of bodily tissues with potential recipients, such as in the case of an organ transplant, or determining relatedness of two or more individuals. The systems and methods described herein may be extended to omic transactions involving non-human species as well, including, without limitation, plants, animals and microbial fauna. These and other types of transactions may be beneficially implemented using techniques and embodiments described herein.

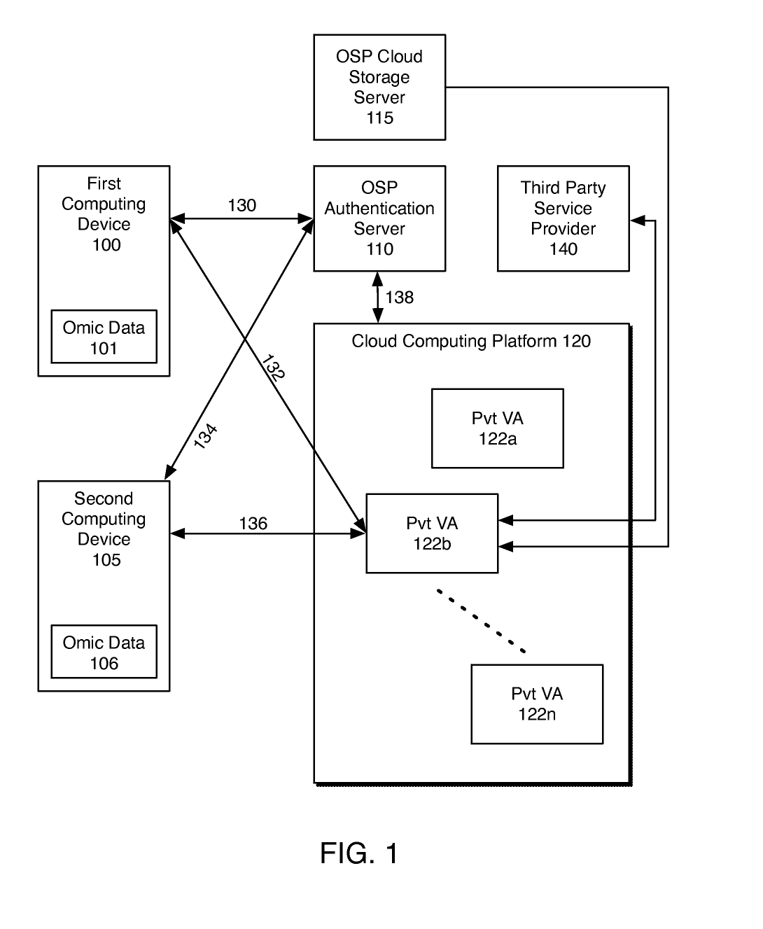

FIG. 1 illustrates an exemplary computing environment for performing omic transactions, according to a first embodiment. In brief overview, the environment includes a first computing device 100, a second computing device 105, an omic service provider (“OSP”) authentication server 110, and a cloud computing platform 120. First computing device 100 and second computing device 105 are typically operated by or under the control of individuals for whom genomic data is available. For example, computing devices 100 and 105 may be personal computers, tablet computers, smartphones, wearable computing devices such as smart watches, portable computing devices such as raspberry pi, servers, or virtual machines. Similarly, OSP authentication server 110 may be implemented locally by an OSP or via cloud resources, and such resources may be physical, virtual, or some combination thereof. While various computing resources are illustrated in FIG. 1 as block elements, sometimes with specific sub-elements, as known in the art of modern computing and networking, such resources can be implemented in a variety of ways, including via distributed hardware and software resources and using any of multiple different software stacks. Resources may include a variety of physical, virtual, functional and/or logical components, such as one or more each of web servers, application servers, computation servers, database servers, messaging servers, storage resources, and the like. Such functionality can be implemented via various combinations of software and hardware resources, such as programmable general purpose microprocessors, application specific integrated circuits, field programmable gate arrays, Boolean circuits and the like. It is also contemplated that the functionality of computing devices can be distributed amongst multiple devices or resources, such as a smartphone interacting with cloud-based data storage or cloud-based virtual machine computation engines. That said, the schematic elements of FIG. 1 will typically include at some level one or more microprocessors and digital memory for, inter alia, storing instructions which, when executed by the microprocessor, cause the resources to perform methods and operations described herein.

Cloud computing platform 120 is preferably implemented using a trusted, public cloud computing platform capable of dynamically generating and decommissioning private virtual appliances. Examples of cloud computing platforms that are currently commercially available and usable for implementation of cloud computing platform 120 include Amazon AWS, Microsoft Azure or Google Compute Engine. However, it is understood that alternative embodiments of platform 120 may be implemented in private cloud or hybrid cloud environments. Preferably, clouding computing platform 120 is capable of rapidly instantiating virtual appliances on demand, such as private virtual appliances 122a through 122n. Each private virtual appliance 122 is preferably provided specifically with applications and data necessary for performance of a specific omic transaction. In other embodiments, private virtual appliances 122 could be instantiated in advance, with idle private virtual appliances on standby awaiting assignment to a particular transaction. While authentication server 110 as described herein may typically be implemented using one or more persistent servers, private virtual appliances 122 are preferably implemented using transitory virtual machines.

Various resources in FIG. 1 are able to communicate with one another via network connections 130, 132, 134, 136 and 138. Network connections 130-138 are preferably digital network connections that include the Internet as a transport mechanism, although it is understood that such connections can readily be, and typically are, implemented via various combinations of private networks, public-private networks, public networks, and the Internet. Preferably, network connections will be established using secure communication protocols where feasible.

### Private Virtual Appliance with OSP-Managed Genome Storage

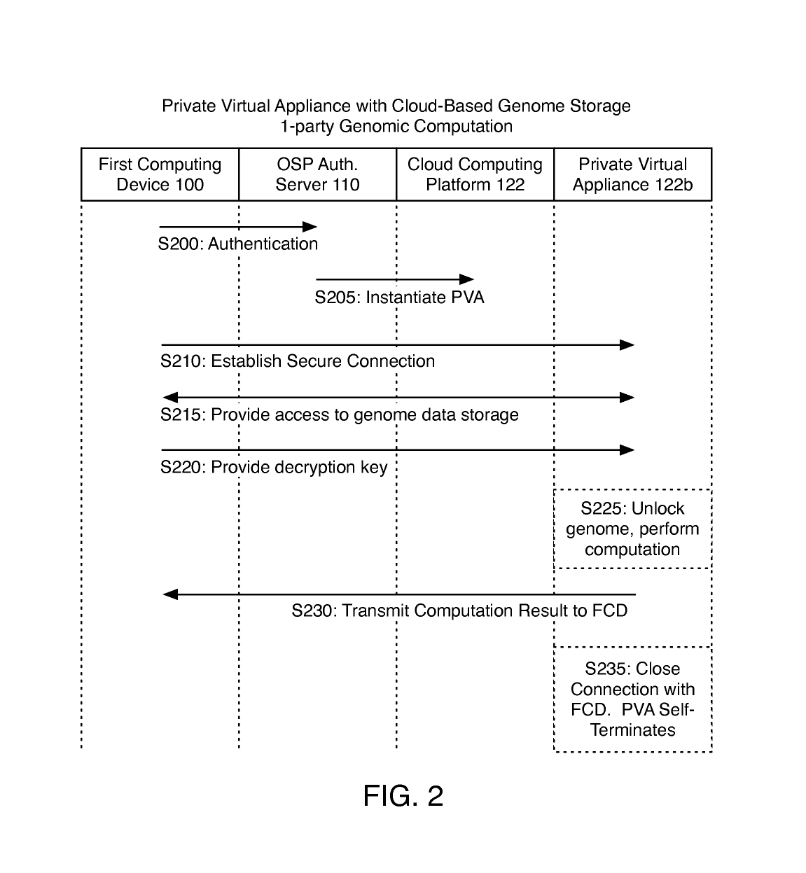

FIG. 2 is a process diagram illustrating performance of a genomic annotation in the computing environment of FIG. 1, using a private virtual appliance and cloud-based genome storage managed by an omic service provider. For purposes of explaining the method of FIG. 2, we can presume that an individual named Bob is using first computing device 100. Bob wishes to obtain interpretation of health risks or ancestry information based on that information. Bob's genome data has been previously encrypted and uploaded to an omic service provider's secure cloud storage server 115. The authenticity of Bob's genome data is verified when first uploaded to cloud storage server 115, as described further hereinbelow. Because Bob's data is pre-authenticated and only available to the omic service provider in an encrypted state, the privacy of Bob's genome data is preserved, while subsequent use of that encrypted data requires only a data integrity check rather than full authentication.

In step S200, Bob uses first computing device 100 to authenticate himself with OSP server 110, such as by using a web browser application operating on first computing device 100 to log in to a secure web service implemented on server 110 via network connection 130. In step S205, OSP server 110 communicates with cloud computing platform 120 via network connection 138 to cause cloud computing platform 120 to instantiate private virtual appliance 122b. Private virtual appliance 122b can be instantiated using any of a number of techniques, including, but not limited to, spawning a new machine from an existing image, and cloning or forking an existing machine. Preferably, cloud computing platform 120 enables rapid instantiation of application-specific private virtual appliances. The instantiation process of step S205 includes the application of customizations for each new private virtual appliance. Amongst the appliance-specific data that is configured within appliance 122b in step S205 is a network connection specification that can be used by appliance 122b to establish a secure connection with first computing device 100 (step S210). In some embodiments, private virtual appliance 122b will have a network connection to first computing device 100, but will not be provided with any communication link to OSP server 110, thereby helping mitigate risk of compromising the security or privacy of Bob's information in the event of malicious activity on the part of the omic service provider.

In step S215, Bob grants access to relevant portions of his pre-authenticated genome data (stored by cloud storage server 115) to private virtual appliance 122b. Preferably, access is granted by configuring private virtual appliance 122b with appropriate metadata when instantiated in step S205, enabling appliance 122b to mount, as a remote volume, an omic data repository within server 115 containing Bob's genome, which is preferably encrypted and pre-authenticated. A pre-authenticated genome is genomic data that has been previously verified as belonging to Bob, and has not been altered in any way.

In step S220, first computing device 100 provides private virtual appliance 122b with a decryption key for Bob's encrypted genome data within repository 101. In step S225, private virtual appliance 122b decrypts genomic data from repository 101 that is necessary to performing the requested omic computation, and performs the computation. In step S230, private virtual appliance 122b transmits the computation result to first computing device 100, for conveyance to Bob. The transaction being complete, in step S235, private virtual appliance 122b closes connection 132 with first computing device 100 and cloud storage server 115, and terminates itself.

This exemplary embodiment includes several characteristics that may be desirable. For example, private virtual appliances 122 are instantiated on-demand, preferably for purposes of a single omic transaction, thereby reducing risk of inadvertently commingling data between different omic transactions. Private virtual appliances 122 may be implemented with little or no communications to entities other than first computing device 100 and cloud storage server 115. By limiting communications between the private virtual appliance and the omic service provider, the system reduces risk of compromising the privacy of Bob's data in the event of malicious action on the part of the omic service provider, such as might occur if omic service provider 110 were hacked or if disgruntled OSP employees sought to misuse clients' private genomic data. Bob's unencrypted personal genome data is never stored by the omic service provider directly; it exists only temporarily, within a cloud-based, single-purpose private virtual appliance which is preferably terminated (with all data deleted) immediately upon completion of the omic transaction for which it was formed.

While in some embodiments the omic computation of step S225 will be performed directly by virtual appliance 122b, in other embodiments the omic service provider may act as a trusted platform facilitating interaction between users and third party cloud or computing resources. The omic service provider's trusted platform may enable more ready interaction between users concerned about privacy, and a broader ecosystem of companies providing value-added, potentially proprietary, omic processing and analysis services. In such an example, in the context of FIG. 1, private virtual appliance 122b may communicate with third party service provider 140 to implement an omic transaction involving the user of first computing device 100 and the process of FIG. 2. However, the omic computation of step S225 may be performed by private virtual appliance 122b collaboratively with third party service provider 140. Some or all of the data and software required to implement the omic transaction may reside with third party service provider 140. The collaboration between appliance 122b and third party service provider 140 can be implemented in a number of ways, preferably via privacy preserving computation protocols.

For example, in some embodiments, appliance 122b and third party 140 may jointly perform an omic calculation using known secure multiparty computation protocols, such as Garbled Circuits or homomorphic encryption techniques, potentially enabling the transaction to be completed without revealing private user data to third party 140, and without third party 140 revealing the details of its proprietary computations or analyses to the omic service provider or end users. In other embodiments, third party service provider 140 may communicate data and/or software required to complete an omic transaction to virtual appliance 122b in step S225 prior to appliance 122b performing the transaction, such that the proprietary data or software of third party service provider 140 is secured by being known only to a transitory, single-purpose virtual appliance and is deleted upon termination of appliance 122b in step S235. In other embodiments, private virtual appliance 122b may promote increased privacy by relaying user omic data to third party 140 for processing anonymously, preferably via a secure channel but without personally-identifiable owner attribution; the omic transaction result is calculated by third party service provider 140 and returned to private virtual appliance 122b, where it is associated with its owner and returned in step S230, thereby shielding the user's identity from third party 140. In yet other embodiments, third party 140 may itself launch a transitory private virtual appliance to which appliance 122b can communicate and complete a transaction. These and other embodiments are contemplated through which an omic service provider can utilize the systems and methods described herein throughout to complete omic transactions involving third parties.

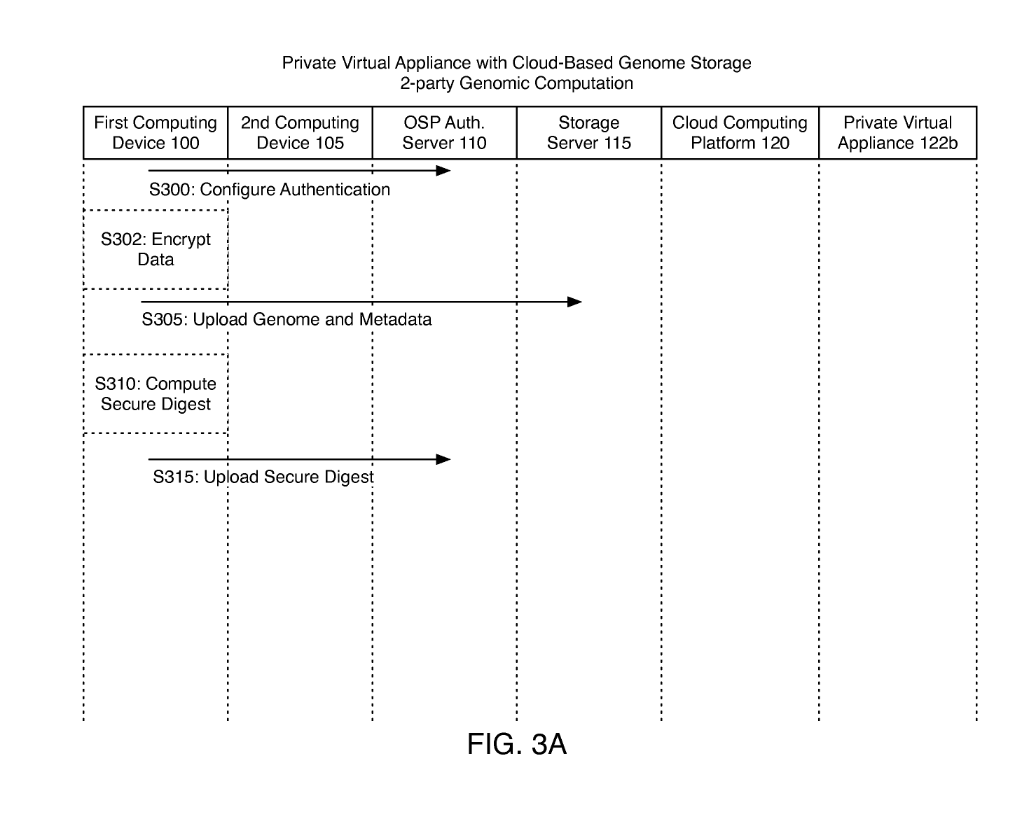

FIGS. 3A and 3B illustrate another exemplary process that may be performed within the computing environment of FIG. 1. Specifically, the process of FIG. 3 demonstrates a two-party genomic computation using a virtual appliance based system with cloud-based genome storage. For purposes of explaining the method of FIG. 3, we can presume that individuals named Bob and Alice seek to check their genetic compatibility in terms of potential health risks of progeny. Bob is using first computing device 100, and Alice is using second computing device 105. In this scenario, we presume Alice is already a registered user of an omic service provider, and has elected to store her genome, encrypted, with the omic service provider, specifically within cloud storage server 115.

The embodiment of FIG. 3A demonstrates a mechanism by which a user can conduct a secure transfer of omic data to an omic service provider. In step S300, Bob, using first computing device 100, communicates with omic service provider server 110 to configure an authentication mechanism for signing into the omic service provider's services. Suitable authentication mechanisms could include, but are not limited to, a strong password, biometric input such as a fingerprint captured via a mobile device fingerprint sensor, pattern input via mobile device touchscreen, or combinations of multiple such mechanisms.

In step S302, Bob (e.g. using first computing device 100) encrypts his genome data and metadata, preferably using an open-source encryption tool compatible with the omic service provider's computing infrastructure, if the data is not already so encrypted. Preferably, Bob will encrypt his genome data in step S302 using a strong password different from that used in step S300 to authenticate with omic service provider authentication server 110, thereby preventing the omic service provider from decrypting Bob's genome data even in the event of malicious action compromising Bob's OSP authentication password and encrypted genome data.

In other environments, it is contemplated that an individual may not have the capability of encrypting their genome data in a manner compatible with the omic service provider's systems, such as a circumstance in which the individual's genome data resides with a third party that does not offer appropriate encryption capabilities. Thus, in some embodiments, step S302 may be performed by a private virtual appliance 122, instantiated by the omic service provider and configured for an encryption operation. This encryption appliance is preferably configured to connect to such a genome data repository using an industry-standard secure channel, such as the HTTPS protocol. The genome data can then be securely transferred to the encryption appliance, where it is encrypted using an encryption key preferably specified by Bob.

In step S305, Bob uploads his genome and associated metadata to storage server 115 from a location in which Bob stores it, such as local device omic data repository 101, a private network server, another cloud storage service or a private virtual encryption appliance (described above). Preferably, the omic service provider provides an interface to facilitate the upload in step S305, such as one or more web pages, a standalone computer application user interface, a mobile device application user interface, an Application Programming Interface (API), or some combination thereof. Once Bob's data has been uploaded, in step S310, first computing device 100 computes a secure digest of Bob's genome and associated metadata, as described further below. In step S315, device 100 transmits the secure digest values computed in step S310 to omic service provider server 110, where they are stored within a database and associated with Bob's records as verified secure digests. In other embodiments, the verified secure digest computation of step S310 can be performed on a secure private virtual appliance 122 instantiated temporarily for purposes of the one-way function operation.

In some embodiments, it may be desirable to undertake additional measures in order to provide additional assurance regarding the provenance of data uploaded in step S310, and in turn increase the reliability of the verified secure digests. For example, in some embodiments, Bob will be required to attest in a legally binding manner (whether electronically or via physical signature) that the data provided by him is his own, accurate, unforged and untampered with. In some embodiments, Bob's genomic data and metadata will be ingested directly from a genomic profiling service that originally generated the data, preferably done at the time of data generation. In some embodiments, Bob will additionally supply information (such as a digital signature signed by a trusted third party) that can be used to ascertain the provenance and accuracy of his genome. Each of these can help assure the accuracy and authenticity of genomic information that is considered pre-authenticated and that is used for generating the verified secure digest.

Another technique that can be utilized in some embodiments to verify the provenance of data uploaded is by profiling of a limited number of genome loci and comparing the results against the full genomic profile supplied by the user. The loci profiled may be selected based on, e.g., known sites of polymorphism in the user's ethnic group. The comparison can be used to assess consistency and prevent fraud or inadvertent mixups. For example, Bob may provide the omic service provider with saliva, skin, hair, or some other readily available biological sample, which can be submitted for processing to a rapid multiplexed genotyping assay, such as Sequenom's iPLEX MassARRAY platform. Data uploaded by Bob in step S310 may be made available immediately, but flagged as “pending verification” in all transactions in which it is being used. Once the results from the assay are obtained and successfully compared to the corresponding SNP positions in the data uploaded in step S310 (e.g., using a threshold match count, Bayesian posterior probability calculation, or some other approach), the data uploaded in step S310 can be considered verified and/or pre-authenticated, and indicated as such in current and future transactions.

In yet other embodiments, sections of the metadata such as instrument model used for profiling, software and version used for analysis, and the date and location of profile generation, will be stored directly in the omic service provider's database, e.g. by server 110. These details could subsequently be used in establishing the provenance of data, aid in assigning confidence in computation results, and aid in qualifying future omic computation results.

Upon completion of FIG. 3A, Bob's omic service provider account is created and active. FIG. 3B illustrates an embodiment of a further technique for performing a two-party omic transaction. In step S350, Alice, using second computing device 105, authenticates herself to omic service provider server 110 if she is not already logged in, and conveys a request for genomic compatibility matching with Bob. OSP server 110 transmits a matching request to Bob's first computing device 100, which Bob accepts and authenticates with server 110 (step S352). Simultaneously, OSP server 110 triggers cloud computing platform 120 to assign a private virtual appliance 122b for the omic computation (step S354), such as by forking a pre-existing, running virtual appliance, spawning a new virtual appliance or assigning a previously-launched, idle private virtual appliance; and applying customization that includes: (1) information used by appliance 122b to establish secure session connections with first computing device 100 and second computing device 105; and (2) metadata enabling appliance 122b to securely mount remote storage volumes within cloud storage server 115 containing pre-verified omic data for Bob and Alice (step S356). In some embodiments, private virtual appliance 122b will have a network connection to first computing device 100, second computing device 105 and storage server 115, but will be provided with few or no other communication links to the omic service provider.

In step S358, Alice is served an interface from appliance 122b through which she provides a decryption key for her omic data, such as a secure web page, application user interface, API or some combination thereof. In step S360, upon accepting the matching request, Bob is also served with a secure web page from appliance 122b through which he provides a decryption key for his omic data. Private virtual appliance 122b then decrypts Bob's and Alice's omic data and stores is locally for processing (step S362). In step S364, appliance 122b performs the requested omic computation. In step S366, results of the omic computation are reported to Bob and Alice, e.g. to first computing device 100 and second computing device 105, respectively. In step S368, private virtual appliance 122b terminates itself, erasing the decrypted genomic data of Bob and Alice.

As in FIG. 2, the embodiments of FIGS. 3A and 3B also facilitate genomic computation without exposing Bob or Alice's unencrypted genomic information to the omic service provider. Because the unencrypted genomic information exists only temporarily, on a transitory single purpose virtual machine, risk of undesired disclosure of omic information can be significantly reduced, even in the event of OSP hacking, malicious action by OSP employees, or other malicious activities. Additionally, in some embodiments, these benefits can be obtained without the increased computational burden and complexity inherent in other solutions that utilize secure multiparty computing techniques to control disclosure of genomic information.

### Private Virtual Appliance With User-Managed Genome Storage

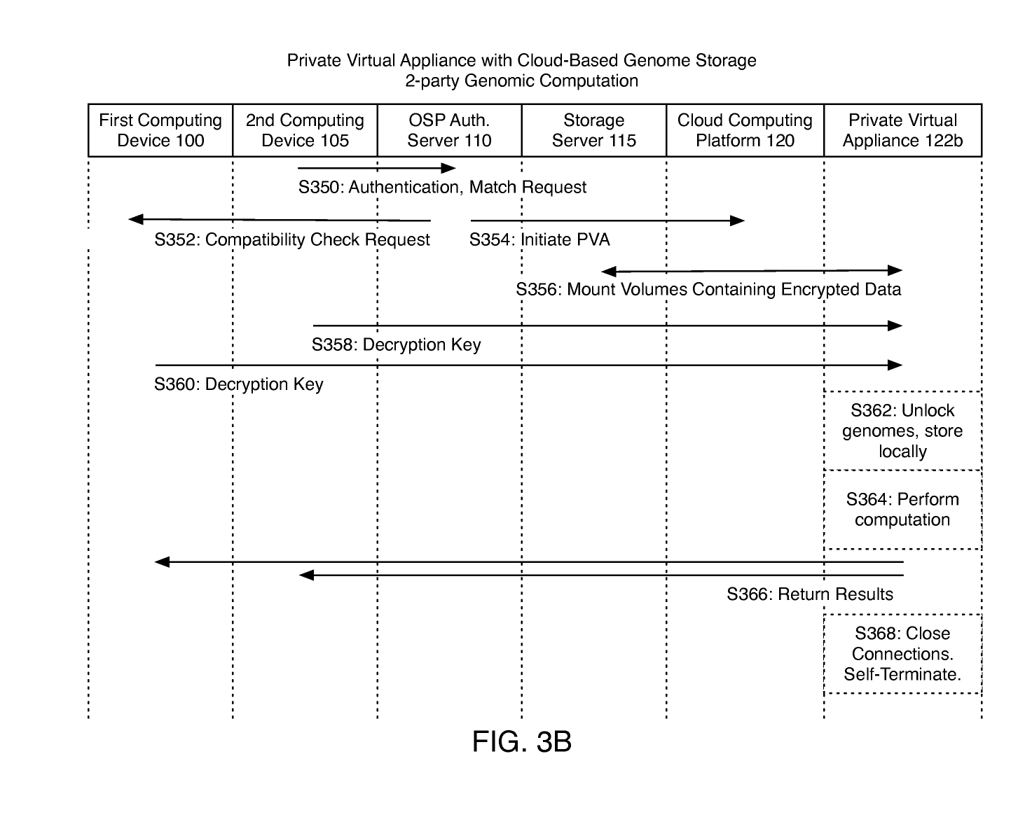

While the embodiments of FIGS. 2 and 3 provide mechanisms to preserve the privacy of personal genomic information, they involve the storage of encrypted genomes in a cloud appliance controlled by an omic service provider. In some applications, it may be desirable to implement omic transactions without trusting the omic service provider with long-term storage of individual genomes. FIGS. 4-6 illustrate several such embodiments, in which genome data can be managed by users.

In FIGS. 4-6, the omic service provider pre-processes the client genomes and metadata to generate a verified secure digest. The verified secure digests are then stored by the omic service provider and subsequently used to establish data authenticity and data quality for the omic transaction parties' omic data.

Prior to a requested omic transaction, a profiling facility is used to generate a genomic profile. The profiling facility may be a sequencing service or company that collects an original biological sample from an individual (typically the owner of the genomic data) in order to obtain a genomic profile. The genomic profile is typically a profile made of one or a combination of genomic, epigenetic, transcriptomic, metabolomics, proteomic, metagenomic, viromic or other such multivariate biological data of an individual. A personal profile is typically a collection of one or more identifying annotations about an individual, such as name, social security number, drivers license number, photograph, fingerprint, biometric measurements or other such data. A sample profile is typically metadata relating to a particular sample analysis performed by a profiling facility. A sample profile may include information such as a profiling facility identifier, a timestamp of the profile generation, identification of equipment used for generating a profile, identification of software used for analysis of a genomic profile, a reference genome version, tissue details (e.g. “skin”, “saliva”, “tumor”, or “normal”) and/or other types of identifying information. Sample profile information can preferably be used to uniquely identify one of multiple genomic profiles that may exist for a particular individual.

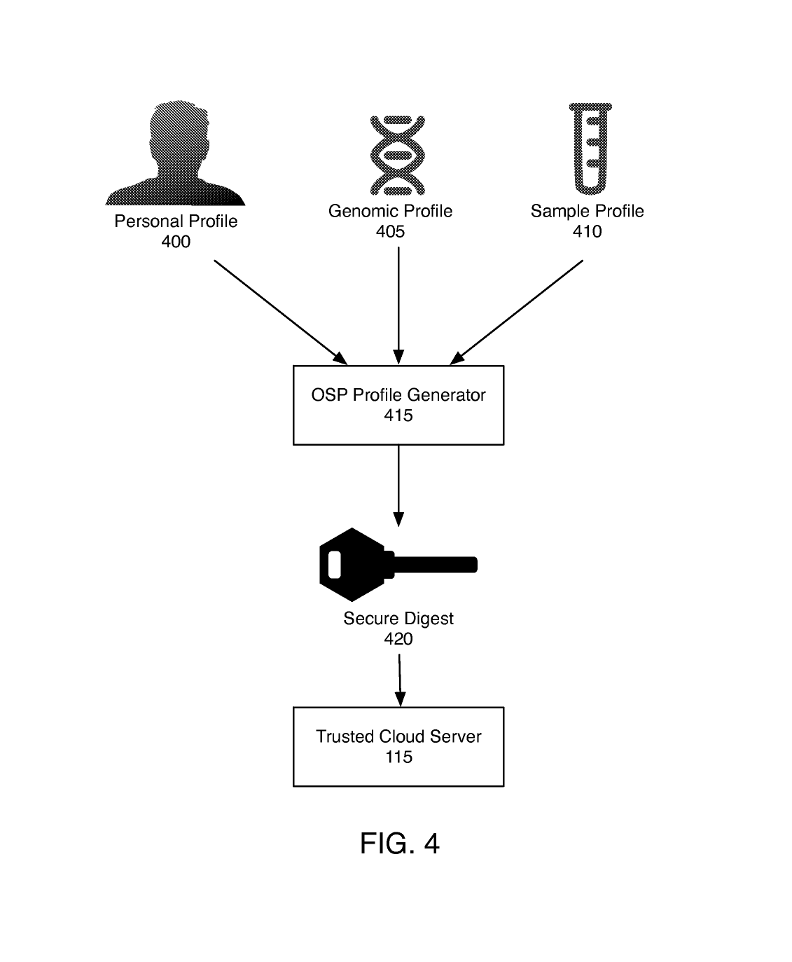

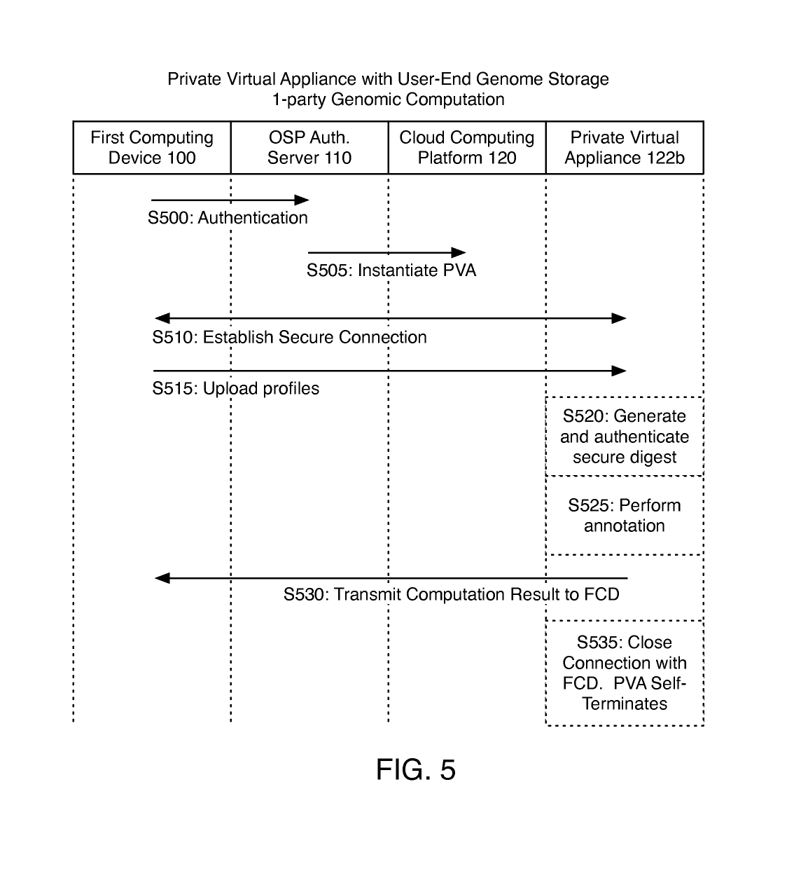

FIG. 4 illustrates a system for creation of a secure digest that can be used for data authentication and verification in the embodiments of FIGS. 5 and 6. Profile Generator 415 obtains as inputs personal profile 400, genomic profile 405 and sample profile 410. Profile Generator 415 utilizes software or hardware to implement a one-way function, such as a hashing technology like SHA-2, for creating secure digest 420 based its input data. In some embodiments and use cases, profile generator 415 is implemented by an omic service provider, and upon generation, secure digest 420 is uploaded to trusted cloud server 115. Secure digest 420 is subsequently easily reproducible given the same personal profile, genomic profile and sample profile, such that comparison of a secure digest value at the time of an omic transaction to a previously-stored, known-authentic value can be performed to confirm that data is authentic and has not been corrupted. At the same time, as long as a cryptographically secure hash function or other one-way function is implemented by Profile Generator 415, storage of secure digest 420 by an omic service provider provides little or no risk to the privacy of the original personal profile, genomic profile or sample profile, even if the security of the omic service provider's secure digest data store is compromised, as it is difficult or impossible to derive original data from a computed secure digest.

FIG. 5 describes performance of a genomic annotation transaction using a private virtual appliance with user-managed genome storage. In step S500, first computing device 100 authenticates with omic service provider server 110. In step S505, OSP server 110 triggers cloud computing platform 120 to start up virtual private appliance 122b. In step S510, a secure session is established between first computing device 100 and private virtual appliance 122b. Preferably, private virtual appliance 122b does not have any direct communications with OSP server 110, thereby reducing risk of compromise in the event of malicious actions by the omic service provider. To facilitate implementation of appliance 122b without communications to the omic service provider, appliance 122b may be instantiated with pre-configured information necessary to accomplish the transactions described herein. Such pre-configured information may include, e.g., secure digests for each party's omic information, and information required for establishing secure communication channels with each of the transaction parties. In step S515, first computing device 100 uploads Bob's omic profile, personal profile and sample profile to private virtual appliance 122b.

In step S520, private virtual appliance 122b generates a new secure digest based on the profile data uploaded in step S515, and compares the newly calculated secure digest against a secure digest previously calculated and stored by the omic service provider corresponding to Bob (see FIG. 4 and associated discussion above). If the newly calculated secure digest is different from the previously-calculated value, authentication fails: preferably, an error message is sent to first computing device 100 for conveyance to Bob, and private virtual appliance 122b terminates itself. If authentication is successful, then the private virtual appliance 122b performs the requested annotation transaction (step S525). Transaction results are sent to first computing device 100 (step S530). In step S535, private virtual appliance 122b ends its secure session with first computing device 100, and terminates itself.

In the embodiment of FIG. 5, the secure digest authentication is useful to ensure that the client's data has not been corrupted accidentally. In a multi-party transaction such as that of FIG. 6, the secure digest authentication described herein can provide multiple safeguards. As in the genomic annotation example, the secure digest authentication guards against errors in data resulting from inadvertent corruption of files. Additionally, the authentication mechanism described herein can be used to guard against errors in data due to malicious tampering by one or more of the parties. A person may choose to manually edit his or her genomic profile or other profile data, such as through modification of a single deleterious base in his or her genome, in order to deceive another party or gain other unfair advantage.

### Applications of Single-Party Computations

The frameworks described in FIGS. 2, 5 and 9 (and elsewhere herein) for single-party computations can be beneficially employed in a variety of omic applications. Some of these are described below.

Annotation of Omic Data Including Assessment of Risk for Diseases:

Bob's genotype is compared against a table of known polymorphisms whose impacts are known independently or in context. Bob's data may include SNPs, copy number variants (CNVs), methylation status and other genomic features. A list of risk and protective genomic features evident in Bob's genome along with their known quantitative effects (ex. odds ratios), disease etiology and descriptions, and suggested medical interventions will comprise the basic output.

In another embodiment, a proprietary risk index will be calculated that combines the curated odds ratios of a wide range of high mortality diseases along with seriousness scores for the diseases. The severity score will qualitatively take into account several relevant factors such as mortality, average age of disease manifestation and prevalence. The list of severity scores will also be customizable based on customer feedback and preference, and will reflect the customers judgment about the relative importance of the diseases in predicting mortality. Known odds ratios for various genomic features will be used as weights for the severity scores to calculate an overall risk index for an individual given his/her genotype. This risk index will be strongly indicative of mortality, with higher values corresponding to individuals at greater risk of contracting or succumbing to a high mortality disease.

Sperm/Egg Donor Bank Searches:

Alice is interested in finding a sperm donor that is genomically compatible with her genomic disease profile. In one embodiment, Alice would like to ensure that her potential sperm donors do not have positive carrier status for any of her own disease risk alleles. Alice's genomic profile is screened against the profiles of all potential donors that are accessible to the OSP-managed cloud locally or at a consenting third party which may be a participating sperm bank.

Assessment of Compatibility for Organ Transplantation:

Bob is suffering from chronic lymphocytic leukemia and needs to find a bone marrow donor for hematopoietic stem cell transplantation. Bob knows the exact alleles at the most relevant human leukocyte antigen (HLA) genes: HLA-A, HLA-B, HLA-C, DRB1, and DQB1. A database of potential databases is available either locally to the OSP-managed cloud or at a participating third party repository like Be The Match registry. A pairwise computation is performed using the single-party protocols with either the cloud-end or user-end storage protocols described elsewhere between Bob and every individual in the registry. At the end of the computation, Bob gets one of the following results: (i) a positive or negative confirmation that at least one match has been found in the marrow registry, given the minimum number of alleles that have been pre-defined to constitute a match; or (ii) the list of individuals that meet the matching criteria, possibly with options for contacting them directly or through the appropriate marrow registry. The secure computation may also include matching or screening potential donors for other characteristics such as age (ex. <50), ethnicity (ex. Caucasian) and gender.

Enrollment in Clinical Trials that Require a Particular Genotype:

Alice wishes to do secure and private check of whether she qualifies for a promising clinical trial. The entity (company, hospital or other such institution) sponsoring the clinical trial shares the qualifying criteria including the required genotype with the OSP. In some examples, the sponsoring entity has an FDA approved genotypic fingerprint criterion that it does not wish to reveal it to Alice. Upon request from Alice, one of the cloud-end or user-end storage protocols described elsewhere is deployed (based on whether Alice's genome is stored on the OSP-managed cloud or elsewhere) and the computation is performed. Alice, and/or the sponsoring entity, is informed whether or not she meets the selection criteria for the trial. The qualifying criteria/fingerprint may not be revealed to Alice if so desired.

Ancestry Determination:

Bob's genome has been profiled either globally across the entire genome or at some minimum number of marker that are informative of ancestry. Any of a number of machine learning, model-based or non-parametric approaches may be used to determine Bob's global and local continental or sub-continental ancestry along with admixture proportions using either the cloud-end or user-end storage protocols described elsewhere. See, e.g., Hajiloo, M., Sapkota, Y., Mackey, J. R., Robson, P., Greiner, R., Damaraju, S. ETHNOPRED: a novel machine learning method for accurate continental and sub-continental ancestry identification and population stratification correction. BMC Bioinformatics. 2013 Feb. 22; 14:61; Nievergelt, C. M., Maihofer A. X., Shekhtman, T., Libiger, O., Wang, X., Kidd, K. K., Kidd, J. R., Inference of human continental origin and admixture proportions using a highly discriminative ancestry informative 41-SNP panel, Investig Genet. 2013; 4: 13; Pritchard, J. K., Stephens, M., and Donnelly, P. (2000) Inference of population structure using multilocus genotype data, Genetics 155, 945-959; Alexander, D. H., Novembre, J., and Lange, K. (2009) Fast model-based estimation of ancestry in unrelated individuals, Genome Res. 19, 1655-1664; Bouaziz, M., Paccard, C., Guedj, M., and Ambroise, C. (2012) SHIPS: spectral hierarchical clustering for the inference of population structure in genetic studies, PLoS ONE 7:e45685; Sankararaman, S., Sridhar, S., Kimmel, G., and Halperin, E. (2008) Estimating local ancestry in admixed populations, Am. J. Hum. Genet. 82, 290-303; Padhukasahasram, B. Inferring ancestry from population genomic data and its applications, Front. Genet., 3 Jul. 2014|doi: 10.3389/fgene.2014.00204.

Omic Profile Based Disease State Estimation:

Bob has data available from his one or more of his genomic, transcriptomic, microbiomic, epigenetic, metabolomic, viromic profiles. The data is available as a static snapshot at a particular time or as a time series. This data can be harnessed to effectively predict Bob's current or imminent disease states. In one embodiment, a supervised learning algorithm is available that has been trained on a vast library of available omic states and their corresponding disease states. Bob's data is used as input to this classifier to predict his disease state or health risks. The output may include suggested clinical interventions. In case all or part of Bob's data resides with a third party (ex. with his clinician's office or hospital), the approach described in [0015] may be implemented.

Rapid Visible Phenotype Estimation:

Alice goes to her doctor and gives him access to her genome, possibly through an electronic storage device on her person such as the genome-on-a-stick embodiments described hereinbelow. Her doctor would like to ensure that the genome belongs to Alice. He could perform a private computation on the provided genome using the OSP-managed cloud that returns a list of evident physical features corresponding to the genome, ex. gender, ethnicity, skin and eye color. This would help him verify the correspondence between Alice and the provided genome to some degree.

### Applications of Multi-Party Computations

The frameworks described in FIGS. 3 and 6 for multi-party computations can be beneficially employed for a variety of omic applications. Some of these are described below.

Compatibility Check with Personalization of Compatibility Scores:

Bob and Alice are performing genomic compatibility check to identify potential risks of genetic disease or other attributes in their potential offspring. Bob believes that the risk of his children inheriting diabetes is not a concern for him because he expects diabetes to be a curable disease in a few years. Similarly Alice is not concerned about cardiovascular diseases, but she is extremely concerned about Alzheimer's disease.

Based on their degree of concern, Bob and Alice are given a choice of encoding their priorities and preferences as weights in the compatibility score. The various disease risks assessed are custom-weighted based on Bob's and Alice′ individual preferences. The compatibility calculation result determination is performed twice, with Bob's and Alice's parameters separately, and their personalized scores are transmitted back to them. These and other implementations of personalized scores, as also described in applicant's co-pending U.S. provisional patent application Ser. No. 61/931,259, filed Jan. 24, 2014, can be readily realized in conjunction with omic transaction frameworks described herein.

Privacy-Preserving Kinship Estimation:

Adam and Bob would like to determine if they are related through a paternal ancestor and would also like to estimate the time to their most recent common ancestor (MRCA). If data from at least a few key positions on the Y chromosome is available for both Adam and Bob, this can be done with several described algorithms (Walsh, B. (2000) Estimating the time to the most recent common ancestor for the Y chromosome or mitochondrial DNA for a pair of individuals, Genetics 156: 897-912; Jobling, M. A., Tyler-Smith, C. (2003) The human Y chromosome: an evolutionary marker comes of age, Nat Rev Genet 4: 598-612; de Knijff, P. (2000) Messages through bottlenecks: on the combined use of slow and fast evolving polymorphic markers on the human Y chromosome, Am J Hum Genet 67: 1055-1061). Depending on whether the data is available locally to the OSP-managed cloud or not, the appropriate frameworks (cloud-end or user-end storage) described herein can be deployed with the MRCA calculation. Other types of kinship estimates such as maternity tests (using the mitochondrial DNA), sibling testing and grandparentage tests may also be performed using the described frameworks.

Consented Privacy-Preserving Data Mining:

A researcher is interested in doing a genome-wide association study to identify variants associated with Type I diabetes and wishes to collaborate with the OSP. The OSP sends a description of the research question to its users and solicits their participation. The users that consent are directed to a PVA which requests access to their genome as described before. In addition, the PVA requests relevant medical and personal details such as age, ethnicity, gender, personal and family history of the disease that are required for the genome-wide association study. Once all users' information is available on the PVA, the computation is performed, the results sent back to the researcher and the PVA terminated.

### Simple Frameworks for Private and Secure Genomic Computation

While paradigms described herein for genomic computation can provide beneficial combinations of privacy, security, authentication and computational efficiency, additional frameworks may be desirable to provide a simpler and more transparent experience by end users. Some embodiments of such frameworks are sometimes referred to herein as “genome-on-a-stick” or “GoaS”. Broadly, genome-on-a-stick can be a portable framework that is simple for end-users to authenticate and perform computations using the virtual appliance-based systems described elsewhere herein. Some embodiments of GoaS involve hardware tokens. Other embodiments of GoaS are implemented using software solutions. For example, GoaS can be implemented using an app operating on a mobile phone.

GoaS typically includes meta-data along with actual genomic data. GoaS metadata includes file metadata with information that describes various properties of the genome as it is stored, and other details. Preferably, GoaS embodiments will include some or all of the following subsections of the metadata:

a) Provenance information. This could include, details about the profiling facility used to sequence the genome, the sequencing technology used, date and time of origination, and in general, any information that authenticates the data.

b) File meta-data. Size and file compression methodology used including any data fragmentation information. For example, if the genome is represented as a difference from a known set of reference genomes, then, this subsection would list the identifiers of those reference genomes.

c) Encryption scheme. Details that would be needed to decrypt the data contained on the genome-on-a-stick. This preferably includes details about the exact algorithm used, but not the information used to unlock the contents itself.

d) Authentication. Information such as secure digests that would be necessary to authenticate the data and some parts of the meta-data itself, such as provenance and file size.

e) Indexing information. The genomic information contained on the Genome-on-a-stick is preferably indexed to enable rapid and granular data retrieval. The meta-data would therefore, also include details about an indexing scheme used as well as actual indexing information of the data. In general, the personal genomic data set PG is comprised of subsets PGS such that PG=PGS₁∪ . . . ∪PGSₙ. The indexing portion of Genome-on-a-Stick will preferably carry information (such as a description and data retrieval details such as location) about each subset.

Embodiments of GoaS further include personal genomic data, preferably comprising encrypted and compressed genomic data that was previously sequenced and stored. The raw sequence data can first be compressed using a suitable compression methodology. In some embodiments, a genome technique uses reference genomes for various segments of a user's genome that tend to exhibit little or no deviation across individuals, such that only deviations from the reference genome need be stored. In some such embodiments, an omic service provider may utilize multiple reference genomes in order to further shrink the genome storage requirements for each user, as the omic service provider will be able to identify a particular reference genome with the least variations from that of a particular user. The user's genome may also be split into segments and the nearest reference for each segment can be selected and used as a reference for that segment. The OSP can have a repository of several fully annotated reference genomes from various races, ethnicities and regions, with several references in each human subtype. The user's genotype is created as SNPs and indels based on the nearest reference genome for each segment. Each segment is later annotated with the reference genome used, according to the OSP's proprietary reference names. This substracted, or “delta” genome is stored in the user's personal devices of choice, encrypted by the user's custom password, biometric input or finger pattern based on his/her choice. The delta genome may be particularly useful in scenarios where the user has opted to dynamically upload each time there is an omic computation. The user's genome can be assembled prior to computation in such cases. In some embodiments, the delta genome can provide several advantages, which may include: (i) using multiple specific reference genomes for different regions of the genome significantly reduces the upload file size, (ii) encryption improves security, and (iii) using multiple custom references where the references are only known to the OSP is equivalent to encoding the genome, which further improves privacy in case the data is compromised on the user's end.

Additionally or alternatively, standard file compression may be applied to the sequence data. The compressed sequence data can then be encrypted using algorithms known in the art that enable parts of the data to be decrypted without requiring all of the data to be decrypted, such as a Merkle hash tree. Embodiments of GoaS may utilize any of a number of different storage options for storing the genomic data, including but not limited to, stand-alone storage media such as a USB storage device, data storage built into one or more personal electronic or wearable devices such as nonvolatile digital memory, and even storage on a networked secure server or a secure storage cloud. Embodiments of GoaS may also allow for data fragmentation, whereby data can be fragmented into a number of actual devices housing the data.

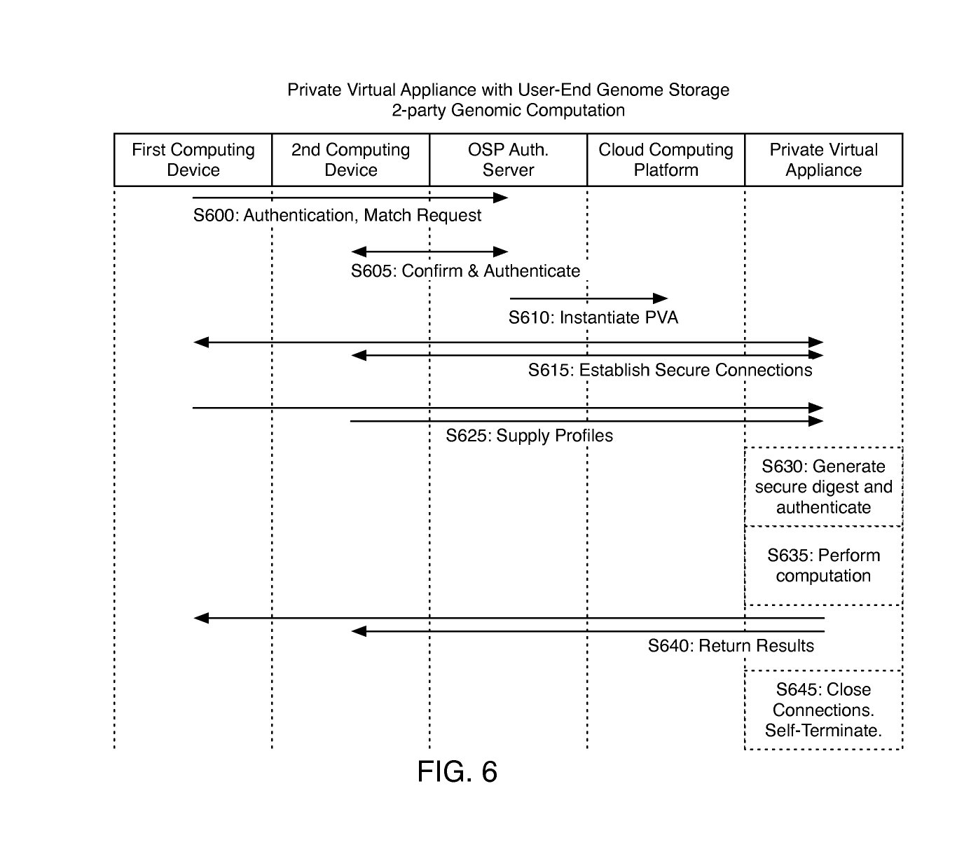

FIG. 7 illustrates an exemplary embodiment of Genome-on-a-Stick. GoaS 700 includes metadata storage 705, containing provenance information 710, file metadata 715, encryption scheme metadata 720, authentication metadata 725 and indexing information 730. GoaS 700 further includes genomic data storage 740, storing encrypted and compressed genomic data corresponding to an individual controlling GoaS 700. In the embodiment of FIG. 7, microprocessor 750 can read and process information from metadata storage 705 and genomic data storage 740, and further communicate with external systems and devices via network interface 760. Depending on the method by which GoaS 700 is to be used, network interface interface 760 may include one or more of: an Ethernet interface, a wireless networking interface, a USB connection or other data communications interface.

Several implementation details of GoaS 700 help address privacy and security challenges discussed elsewhere herein. For example:

Personal Genome Privacy: People may want to explore their personal omic data (e.g., to determine ancestry, relatedness, or medical vulnerabilities) without revealing either their personal identity or the information gleaned from their genome to other parties. People may also wish to engage in genomic transactions involving other people (e.g. to determine relatedness or genetic compatibility in terms of predicted health of potential progeny) but do so in a manner that does not reveal their data to the other individual or to any third party which might be providing the service. This can be achieved with the help of encryption. The personal genomic data is encrypted using a series of keys that allows for the decryption of a subset of the genome. As an example, let us consider that the genomic data set PG is comprised of subsets PGS such that PG=PGS₁∪ . . . ∪PGSₙ. A set of symmetric keys {K₁ . . . Kₙ} encrypt (decrypt) the set PG such that a key Kᵢ will encrypt (decrypt) subset PGSᵢ. As another example, consider the genomic data set PG to be comprised of subsets PGS such that PG=PGS₁∪ . . . ∪PGSₙ and a set of keys {(K₁K₁′) . . . (KₙKₙ′)} encrypt the set PG such that a key Kᵢ will encrypt subset PGSᵢ whereas, key Kᵢ′ will decrypt the subset PGSᵢ. Either such encryption technique can be beneficially employed in connection with certain embodiments described herein.

“Plug and Play” genomic processing: With a number of service providers, applications, and omic data storage options, end-consumers may desire the freedom to, (a) choose the method of secure storage of their personal genomic data, (b) easily and securely retrieve the data from the storage device or service, and (c) use their favorite application to process the genomic data. Additionally they will likely want the process to be simple. The underlying genomic data storage and processing technology will, therefore, preferably enable this “plug and play” model for genomic data processing. With the storage scheme of personal genome outlined in the preceding paragraphs, it would be possible to decrypt a portion of the personal genome. An application interacting with GoaS 700 can use the indexing information to request only the snippet of the genome that is of interest, such that disclosure of the full genome stored on GoaS 700 is avoided, even in encrypted form. If the application implements secure and private personal genome mining techniques, then it can ensure that there is no leak of this information to unauthorized parties.

Personal Genome Authentication: Transactions involving personal genomic data should preferably be safeguarded against spoofing and genome manipulation attacks. In multiparty omic transactions involving trust there should be protection against data tampering by any party. Additionally, if an unauthorized party gets access to a person's genomic data (e.g., sequencing with the help of hair samples), they should not be able to use that information to either profit from it, or to get access to other personal information (e.g., bank account or match registry) of the compromised individual. Traditional simple entity authentication that is mostly focused on authenticating the entity or individual performing the transaction will typically be insufficient to safeguard against these types of attacks. Personal genome authentication, a paradigm different from entity authentication that focuses on authenticating the person or entity logging in, is needed here. In the case of personal genomes, we may be interested in, (a) authenticating that the person/entity using the system really owns the genomic data (entity authentication), and also, importantly, (b) that the genomic data that the person/entity is furnishing is indeed the same as data that was sequenced earlier. Such genome authentication, or authenticating the individual with his or her sequenced genome, may be desirable. Certain embodiments of personal genome authentication can be implemented via two steps. At first, the personal genome, and associated meta-data from the framework, is used to generate an authentication digest. This digest gets stored with the omic service provider. Then, before the data is used, this digest is computed afresh and compared with the digest stored with the omic service provider.

Omic Data Verification: Omic data may be of varying qualities, formats and types depending on the source, the sequencer and other aspects. To facilitate omic transactions, it may be desirable to provide standardization as well as a capability to differentiate a variety of data sets. Consumers who get their genes sequenced commercially can do so with confidence that they are getting their money's worth, with the help of technology that generates tamper-proof genomic data as output with verifiable credentials of the sequencing technology used. Considering potential market and technology fragmentation, it may also be desirable to provide a provenance regarding the originating service provider for all omic transactions. This can be assured with the help of provenance data and personal genome authentication outlined above. Once the genome has been authenticated, the provenance information can be used to verify details of the sequencing itself.

Private personal genome mining: It may also be desirable to facilitate end users' ability to perform annotations, analyze ancestry and conduct other exploration of one's own genome.

While GoaS 700 presents an exemplary embodiment, it is contemplated and understood that alternative implementations can be readily implemented by one of ordinary skill in the art, given the teachings herein. Other implementations of GoaS include a small hardware token, an application on a mobile platform, or an application executing within a web browser.

In a GoaS embodiment such as that of FIG. 7, containing an embedded microprocessor, the microprocessor can optionally implement a small, embedded OS. GoaS metadata storage 705 can include metadata to authenticate the GoaS user. The genome data itself can be stored locally, encrypted, within genome data storage 740, or remotely. Using the OS, microprocessor 750 can utilize a Virtual Private Network (VPN) protocol for the connection to cloud server 115 and virtual appliances 122 through network interface 760. In some embodiments, using a VPN protocol to connect can provide multiple advantages over other secure protocols (e.g. HTTPS). VPN allows GoaS 700 to run the client-side application in a sandbox environment, better protecting the user from various kinds of attacks. Using VPN also allows ease of development of server-side backend applications because the application does not have to be aware of the connection protocol being used.

The GoaS structure of FIG. 7 could also be utilized to implement omic transactions, even without use of cloud servers for computation. Instead, computation that would otherwise be performed by, e.g., virtual appliance 122, could alternatively be performed on the ‘stick’ itself, via microprocessor 750. In such an embodiment, communication to other parties could take place through network interface 760 and/or local area network connections, such as Wifi, Bluetooth or NFC. In another embodiment having an OS on the stick, communications with another other party may happen through a local network connection such as Wifi, Bluetooth or NFC, but the computation itself would still be performed using cloud computing resources.

While the GoaS embodiment of FIG. 7 has been described above in the context of private virtual appliance systems for conducting omic transactions, such as those described in connection with FIGS. 1-6, it is also contemplated and understood that GoaS embodiments described herein could also be beneficially utilized in connection with other types of platforms for omic transactions, including, without limitation: systems utilizing secure multiparty computation techniques such as those described in the applicant's co-pending U.S. provisional patent application Ser. No. 61/931,259, filed Jan. 24, 2014; and homomorphic encryption based systems such as that described below. In such embodiments, GoaS 700 may perform some or all of the functionality described in connection with user computing devices, such as a first computing device and (for two-party transactions) second computing device. Moreover, the actual genomic computation could be performed on GoaS 700, on the cloud or using other computing resources.

### Omic Computation with Homomorphic Encryption

Other embodiments may utilize homomorphic encryption methods to reduce risk of inadvertent disclosure of genomic information. Homomorphic encryption is a kind of encryption that allows certain types of computations to be performed on the encrypted data, to generate an encrypted result. The encrypted result can be decrypted using the same key that was used to encrypt the inputs. In the context of an omic transaction, homomorphic encryption could enable an omic service provider to accept encrypted genome data, perform computations on that encrypted genome data, and return a result that can then be decrypted by the party providing the encrypted input data. Thus, the omic service provider never need access to users' decrypted genome data.

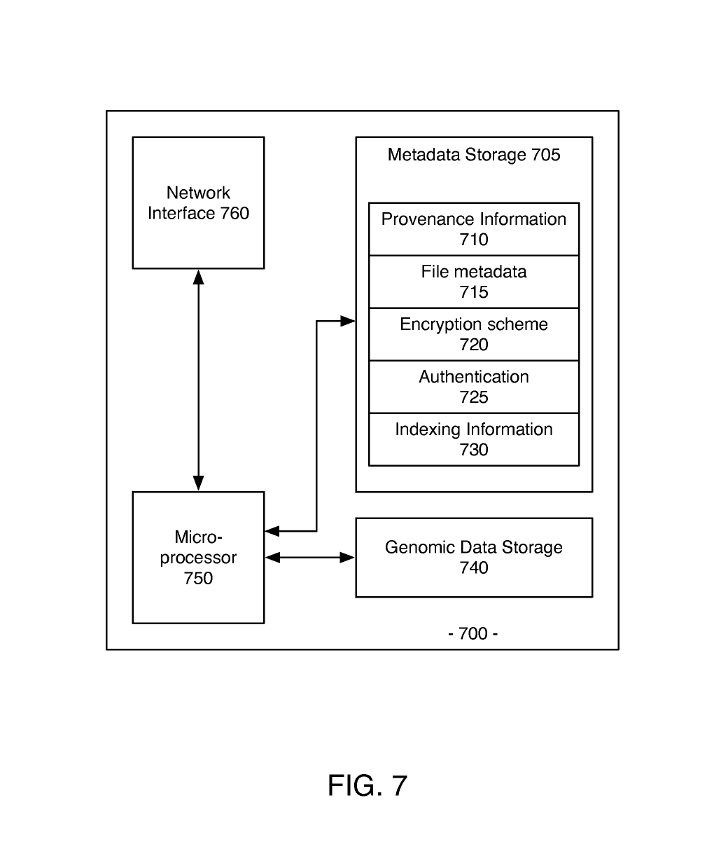

While homomorphic encryption techniques may minimize opportunities for malicious access to an individual's decrypted omic information, it still may be desirable for such implementations to provide for authentication and verification of input data to ensure that individuals do not inadvertently or intentionally modify their genome data before sending it to an omic service provider for processing. FIG. 8 illustrates a computing environment for conducting an omic transaction using homomorphic encryption with authentication and verification. Individuals Bob and Alice utilize first computing device 800 and second computing device 805, respectively. First computing device 800 includes omic data repository 801. Second computing device 805 includes omic data repository 806. An omic service provider implements authentication server 810 and computation server 815. The various servers and devices communication via network 820, which preferably includes the Internet.

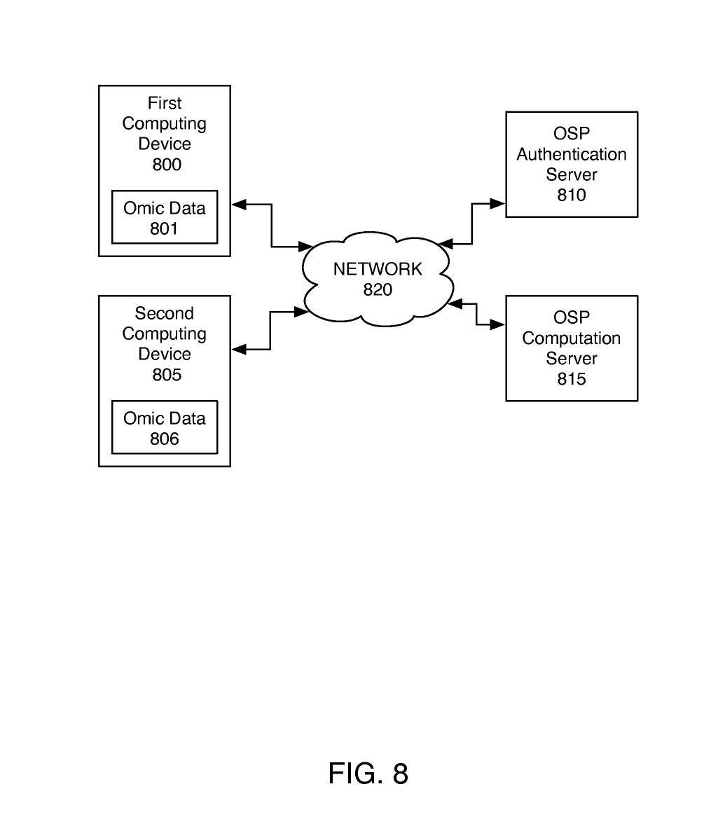

FIG. 9 illustrates a homomorphic encryption-based technique for conducting an annotation transaction within the environment of FIG. 8. In step S900, Bob (using first computing device 800) authenticates with omic service provider authentication server 810. In step S905, Bob is connected to an omic service provider computation server 815. In step S910, Bob grants computation server 815 access to relevant portions of his encrypted genome. In embodiments in which first computing device 800 stores Bob's encrypted genome locally in data repository 801, Bob may provide metadata in step S910 enabling server 815 to mount repository 801 as a remote storage volume. In other embodiments, other protocols could be utilized to provide computation server 815 with access to data within genome repository 801. In yet other embodiments, such as if Bob stores his omic data in a cloud-based storage repository rather than locally within first computing device 800, step S910 may involve Bob providing computation server 815 with metadata enabling access to the corresponding cloud-based data storage systems to enable reading of Bob's encrypted genome data therefrom.

In step S915, computation server 815 performs a homomorphic computation of a secure digest, as described above in connection with FIGS. 4-6 but utilizing homomorphically encrypted omic data and metadata as inputs. In step S920, computation server 815 queries authentication server 810 for a previously-computed, pre-authenticated secure digest associated with Bob, and compares the pre-authenticated secure digest value with the secure digest value computed in step S915. If the values differ, the omic data provided by Bob in step S910 is considered to be unreliable, and the omic transaction is preferably terminated.

If the secure digest values are consistent, Bob's omic information is considered to be authenticated and verified. Accordingly, in step S925, computation server 815 performs the desired computation homomorphically on Bob's encrypted omic data. In step S930, computation server 815 transmits the encrypted computation result to first computing device 800. In step S935, first computing device 800 decrypts the computation result, using the same key that was originally utilized to encrypt the omic information provided in step S910. In step S940, computation server 815 closes its secure connection with first computing device 800.

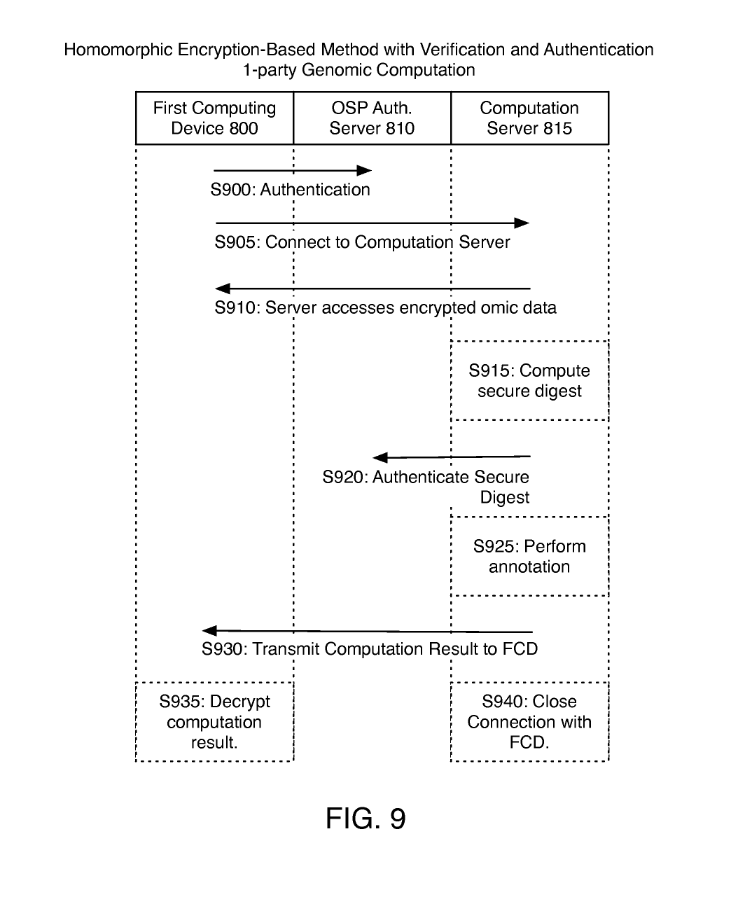

In addition to annotation transactions such as that of FIG. 9, homomorphic techniques can also be utilized to provide secure, authenticated and verified omic transactions amongst multiple parties. FIG. 10 illustrates such a transaction in the context of the computing environment of FIG. 8. In an exemplary application of the embodiment of FIG. 10, an individual named Bob is utilizing first computing device 800, and an individual named Alice is utilizing second computing device 810. Bob and Alice would like a third party omic service provider to provide an analysis of their genomic information to determine compatibility in terms of potential health of progeny.

In step S1000, Bob and Alice authenticate themselves with omic service provider authentication server 810. While illustrated in FIG. 10 as an initial step performed at a time coinciding with the consummation of an omic transaction, it is understood that in other embodiments authentication of Bob and/or Alice could be accomplished at different points within the course of an omic transaction. For example, Bob and/or Alice could have previously logged into OSP authentication server 810 and remained “logged in” through the point at which the omic transaction is initiated. However, preferably, Bob and Alice will each authenticate with OSP authentication server 810 prior to their conveying omic data to computation server 815.

In step S1005, Bob requests matching with Alice. In step S1010, server 810 transmits a matching request to Alice, which Alice accepts. In step S1015, computation server 815 is generated. In some embodiments, computer server 815 can be a single purposes virtual machine generated on demand within a trusted cloud computing platform, such as by instantiating a virtual machine having no or little direct communication with OSP server 810 and having secure sessions with Bob (i.e. first computing device 800) and Alice (i.e. second computing device 805), analogously to private virtual appliances 122 described above. In other embodiments, compute server 815 can be implemented on an untrusted cloud computing platform, or as a local compute resource controlled by the omic service provider. While use of untrusted clouds or private OSP compute resources may provide greater risk of malicious actions, in certain embodiments of the homomorphic encryption-based techniques described herein, the compute server never accesses unencrypted omic data, thereby reducing the risk of privacy loss.

In step S1020, Bob and Alice evolve a common encryption key over open channels. In step S1025, Bob and Alice grant to computation server 815, access to relevant portions of their genomes homomorphically encrypted using the encryption key evolved in step S1020.

Computation server then authenticates the omic data provided to it by Alice and Bob. Specifically, in step S1030, computation server 815 computes secure digests based on omic information and metadata provided by each of Bob and Alice, as described above in connection with FIGS. 4-6. In step S1035, for each of Bob and Alice, compute server 815 compares the secure digests computed in step S1030 with secure digests previously calculated and associated with Bob and Alice in the records of authentication server 810. On successful authentication, compute server 815 performs the desired computation homomorphically, operating on the encrypted data provided by Bob and Alice in step S1025 (step S1040). In step S1045, compute server 815 returns the encrypted result to Bob and Alice. Bob and Alice, using first and second computing devices 800 and 805, can decrypt the computation results (step S1050), and compute server 815 can terminate its secure sessions with devices 800 and 805 (step S1055).

A different approach to use of homomorphic encryption in an omic transaction is described by PCT Published Patent Application WO 2014/040964A1. That approach is analogous to a double-turn deadbolt, where the private key can be split into two private keys that accomplish progressive decryption. The '964 A1 approach may be effectively used for, e.g., analyzing a single patient's omic data, whether in the context of a medical service provider such as a hospital (referred to as MU in the publication) or in a direct-to-consumer genomics service context. However, the '964 A1 approach may not enable cloud-based computation for multi-party omic transactions, such as compatibility assessment, without either compromising data privacy to the cloud provider, or having unencrypted data storage on the user's device, even if transiently. If datasets for multiple users are residing on a cloud storage resource, for couple compatibility assessment using a homomorphic function, both datasets would be encrypted using the same public key. This means that, in a compatibility assessment between Alice and Bob, either Alice's data or Bob's data that is originally encrypted by their own public keys, must be decrypted so that is can be re-encrypted using a common key (e.g. the other user's public key). To the extent that this decryption and re-encryption must be performed by the omic service provider, omic data for all but one of the parties will be exposed to the omic service provider.

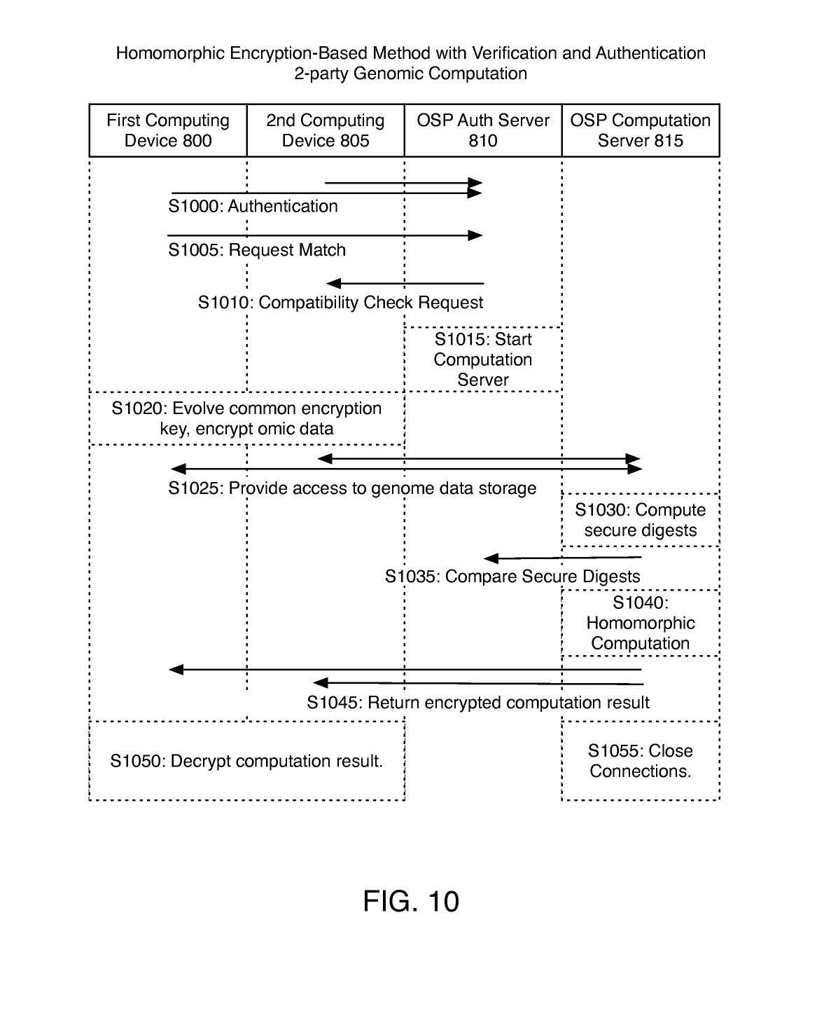

FIG. 11 illustrates a technique for application of principles described hereinabove to enable secure implementation of a split-key analysis in the context of a multi-party omic transaction. Additionally, the embodiment of FIG. 11 eliminates a potential vulnerability of the '964 A1 technique in the case of collusion between the omic service provider and medical service provider, where one party can end up with both partial keys.

In step S1100, Bob sends his public key to Alice, either directly or via the omic service provider. In step S1105, Alice encrypts her genome using Bob's public key on her local device. In step S1110, Alice and Bob transmit their encrypted omic data (both encrypted with Bob's public key) to computation server 815. In step S1115, computation server 815 performs an omic computation by applying a homomorphic function to the data transmitted in step S1110. In step S1120, Bob sends a first part of his private key to the omic service provider. In step S1125, the omic service provider partially decrypts the computed result using the partial key provided in step S1120. In step S1130, the omic service provider transmits the partially-decrypted result from step S1125 and sends it to both Alice and Bob. In step S1135, Bob sends the second part of his private key to Alice. In steps S1140 and S1145, Bob and Alice each fully decrypt the result using Bob's second key.

While the embodiment of FIG. 11 could be implemented in the context of a static computation server 815, preferably, computation server 815 could be implemented as a transitory private virtual appliance, instantiated for purposes of a particular omic transaction and terminated following completion of the transaction, as described hereinabove. Additionally, the technique of FIG. 11 can be implemented with authentication processes described elsewhere herein, including, without limitation, that of steps S1000 through S1015 in the embodiment of FIG. 10.

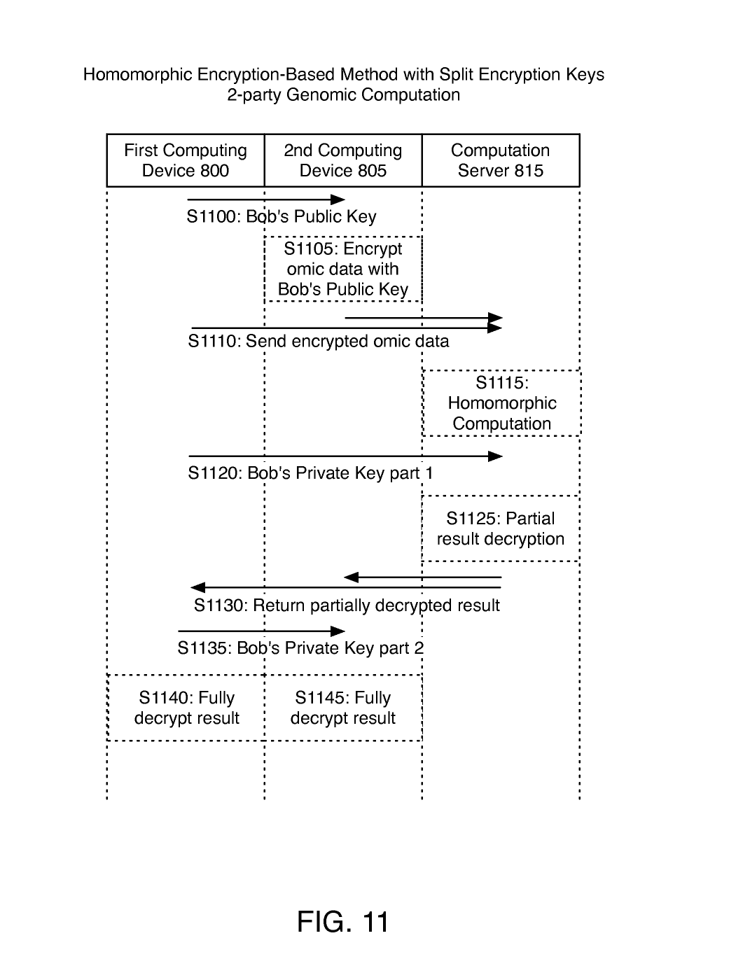

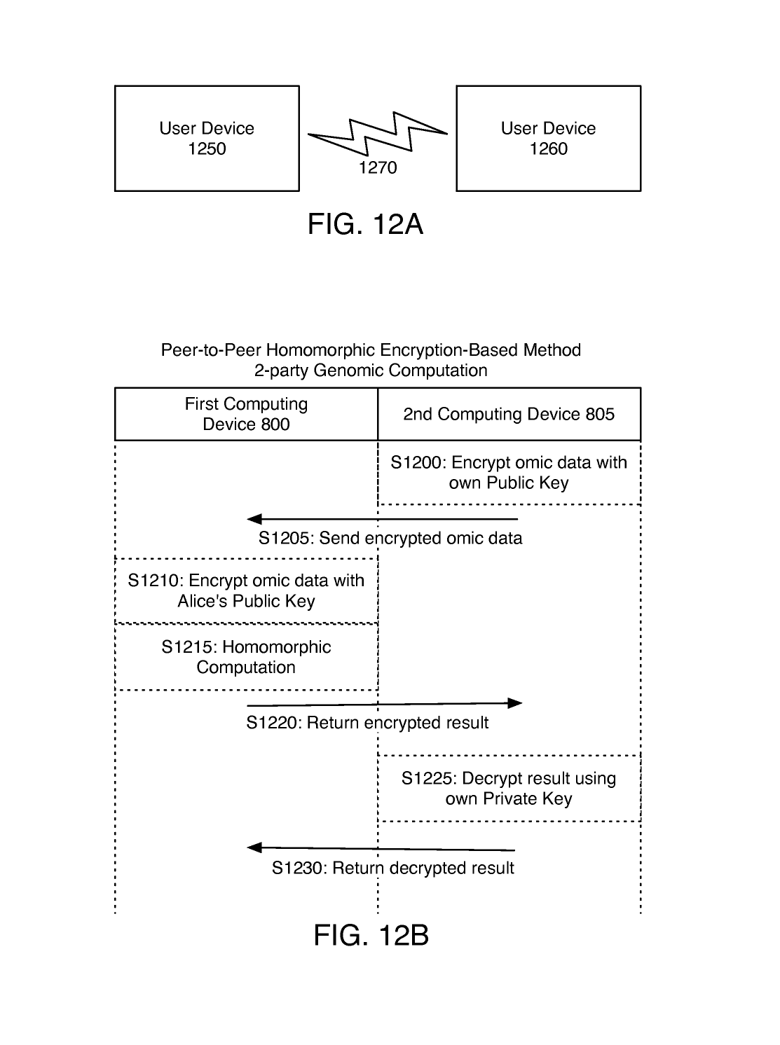

In another embodiment, homomorphic functions can be utilized to achieve secure omic transactions with a peer-to-peer omic computation model. Peer-to-peer computation may be particularly effective and easy-to-use when users employ genome-on-a-stick devices as described above. Such an embodiment is illustrated in FIGS. 12A and 12B. FIG. 12A illustrates a peer-to-peer omic transaction environment. User devices 1250 and 1260 communicate using communications link 1270. In some embodiments, user devices 1250 and 1260 are each implementations of genome-on-a-stick devices, as described hereinabove in connection with FIG. 7. Preferably, communications link 1270 is a secure and high bandwidth peer-to-peer data interconnect, such as NFC, WiFi, Bluetooth 4 or the like.

FIG. 12B illustrates a technique for performing a two-party omic transaction in the peer-to-peer environment of FIG. 12A. In step S1200, Alice encrypts her omic data using her own public key. In some embodiments, step S1200 is performed directly on user device 1250. In step S1205, Alice's encrypted data from step S1200 is transferred from her user device 1250, to Bob's user device 1260 via communications link 1270. In step S1210, Bob encrypts his own data using Alice's public keys, which encryption will be performed in some embodiments directly by user device 1260. In step S1215, Bob, preferably via user device 1260, performs an omic computation applying homomorphic functions to Alice's omic data transferred in step S1205, and Bob's own data encrypted in step S1210. In step S1220, Bob returns the encrypted result of step S1215 to Alice by transmitting the encrypted result from user device 1260 to user device 1250 via communications link 1270. In step S1225, Alice decrypts the result using her private key, preferably via a decryption computation performed directly on user device 1250. In step S1230, Alice returns the decrypted result to Bob, e.g. by transmitting the decrypted result from user device 1250 to user device 1260 via communications link 1270. Thus, Alice and Bob are able to securely perform a two-party omic transaction using their own computing devices, without exposing their decrypted omic data to one another or to any third party.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

For example, while certain system infrastructure elements are illustrated in particular configurations, it is understood and contemplated that functional elements described herein can be readily integrated and/or implemented via various alternative hardware or software abstractions, as would be known to a person of skill in the field of information systems design. The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Any computer programs within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language. Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices; firmware; programmable logic; hardware (e.g., integrated circuit chip, electronic devices, a computer-readable non-volatile storage unit, non-volatile memory, such as semiconductor memory devices, including EPROM, EEPROM, and flash memory devices); magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). These and other variations are contemplated for beneficial implementation of the teachings herein.

1. An omic transaction service hosted on one or more servers communicating with one or more users via a digital communications network to execute an omic transaction, the servers having one or more processors and memory storing instructions which, when executed by the processors, cause the servers to perform a method comprising:
instantiating a virtual appliance;
receiving by the virtual appliance one or more sets of encrypted omic data, each set of encrypted omic data being associated with one of said users;
receiving by the virtual appliance a decryption key for each set of encrypted omic data;
decrypting by the virtual appliance the encrypted omic data using said decryption keys to generate decrypted omic data;
performing by the virtual appliance an omic transaction comprising calculations performed using said decrypted omic data, to generate a transaction result;
transmitting the transaction result to one or more of the users; and
terminating the virtual appliance.

2. The service of claim 1, in which the step of instantiating a private virtual appliance comprises the substeps of: transmitting a request to a trusted cloud computing platform to start a new virtual machine; and configuring said new virtual machine with metadata enabling establishment by the virtual machine of a secure communications connection with computing devices operated by said users.

3. The service of claim 1, in which the step of instantiating a private virtual appliance comprises the substeps of: prior to initiation of an omic transaction, instantiating one or more virtual appliances; maintaining said virtual appliances idle on standby; receiving a request for an omic transaction; and assigning one of said idle virtual appliances to the omic transaction.

4. The service of claim 1, in which the step of receiving by the private virtual appliance one or more sets of encrypted omic data is comprised of the substeps of: establishing secure data connections with computing devices operated by each of said users; and copying said sets of encrypted omic data from said computing devices via said secure data connections.

5. The service of claim 4, the method further comprising: receiving and storing a verified secure digest for each set of omic data, each verified secure digest having been previously generated by applying a predetermined one-way function to pre-authenticated omic data associated with said users;
calculating a current secure digest for each set of omic data, the current secure digest being generated by applying said predetermined one-way function to said decrypted omic data; and
determining that said omic transaction has failed authentication if, for any user, the current secure digest is inconsistent with the verified secure digest.

6. The service of claim 4, in which said pre-authenticated omic data associated with said users is received by one or more of said servers directly from a genomic profiling service having generated the data from a biological sample.

7. The service of claim 1, the method comprising the preceding steps of: encrypting by each user a set of omic data; and uploading said encrypted omic data to a cloud data storage repository, without uploading keys to decrypt said encrypted omic data;
and in which the step of receiving by the private virtual appliance one or more sets of encrypted omic data comprises the substep of copying said sets of encrypted omic data from said cloud data storage repository to said virtual appliance.

8. The service of claim 1, in which the step of performing by the virtual appliance an omic transaction comprises the substep of communicating with a third party server to jointly perform said calculation using a privacy preserving protocol.

9. The service of claim 8, in which the substep of communicating with a third party server to jointly perform said calculation using a privacy preserving protocol comprises jointly performing a secure multiparty computation with a third party server using Yao's Garbled Circuits protocol.

10. The service of claim 8, in which the substep of communicating with a third party server to jointly perform said calculation using a privacy preserving protocol comprises:
receiving from the third party server, by the virtual appliance, software for performing an omic transaction; and
executing said software by the virtual appliance in connection with the decrypted omic data to generate the transaction result.

11. The service of claim 8, in which the substep of communicating with a third party server to jointly perform said calculation using a privacy preserving protocol comprises:
transmitting the omic data to the third party server without personally identifiable user attribution;
receiving a transaction result from the third party server; and
associating the transaction result with the one or more users with whom the omic data was associated.

12. A method for authenticating an omic transaction performed by an omic service provider using omic data associated with one or more users, the method comprising:
receiving and storing verified secure digests of omic data associated with each user, the verified secure digests being generated by applying a predetermined one-way function to pre-authenticated omic data associated with each user;
upon initiation of an omic transaction: receiving a set of omic data associated with each user; generating current secure digests for each set of omic data received by applying said predetermined one-way function; retrieving said verified secure digests; and
determining that authentication of said omic transaction has failed if, for any of said users, the current secure digests are inconsistent with the verified secure digests.

13. The method of claim 12, in which the step of receiving and storing verified secure digests is performed by a persistent storage server; and in which the steps performed upon initiation of an omic transaction are performed by a transitory virtual appliance.

14. An end-user controlled electronic system for facilitating an omic transaction involving one or more third parties, the system comprising:
an omic data storage repository containing an encrypted set of omic data comprising multivariate biological data regarding an individual and metadata associated therewith;
a microprocessor in operable communication with said omic data storage repository,
a communications network interface enabling data communications between said microprocessor and one or more third party electronic systems operated by said third parties;
the microprocessor adapted to perform a method comprising:
decrypting said set of omic data;
calculating a secure digest by applying a predetermined one-way function to said decrypted set of omic data;
transmitting the encrypted set of omic data and the secure digest to a first one of said third party electronic systems;
engaging in an omic transaction with the first of said third party electronic systems.

15. The system of claim 14, in which said omic transaction comprises a calculation performed on genomic data to determine kinship between two or more individuals.

16. The system of claim 14, in which said system comprises a portable electronic device, and said omic data storage repository comprises nonvolatile digital memory.

17. The system of claim 14, in which said omic data storage repository comprises a networked cloud data storage system in communication with said microprocessor via said communications network interface.

18. The system of claim 14, in which the step of engaging in an omic transaction with the first of said third party electronic systems comprises the substeps of:
authenticating with said first third party electronic system;
upon successful authentication, transferring to the first third party electronic system a decryption key for use in the omic transaction, the decryption key being operable to decrypt said encrypted set of omic data;
receiving a result of said omic transaction from the first third party electronic system.

19. The system of claim 18, in which said first third party electronic system comprises a transitory virtual appliance that is terminated following completion of the omic transaction.

20. An omic transaction service hosted on one or more servers communicating with one or more users via a digital communications network to execute an omic transaction, the servers having one or more processors and memory storing instructions which, when executed by the processors, cause the servers to perform a method comprising:
pre-associating at least one verified secure digest with each of said users, the verified secure digests being generated by applying a predetermined one-way function to pre-authenticated sets of omic data;
upon initiation of said omic transaction, establishing secure communication channels with one or more omic data storage repositories;
transferring from said omic data storage repositories one or more encrypted sets of omic data;
generating a current secure digest for each encrypted set of omic data by applying the predetermined one-way function to each of said encrypted sets of omic data;
determining that said omic transaction has failed authentication if, for any user, the current secure digest is inconsistent with the verified secure digest;
performing calculations on said encrypted sets of omic data using homomorphic functions to generate an encrypted transaction result; and
returning said encrypted transaction result to said one or more users.

21. The system of claim 20, in which each set of omic data comprises a personal profile, a genomic profile and a sample profile.
